(19) United States
(12) Patent Application Publication
(10) Pub. No.: US 2011/0052946 A1
(43) Pub. Date: Mar. 3, 2011

(54) SAFETY MECHANISM FOR ELECTRIC MECHANISMS OPERATING ACCORDING TO GALVANIC PRINCIPLES

(76) Inventors: Tim Schaefer, Niedersachswerfen (DE); Andreas Gutsch, Luedinghausen (DE)

(21) Appl. No.: 12/812,863

(22) PCT Filed: Jan. 20, 2009
(86) PCT No.: PCT/EP2009/000328

§ 371 Date: Jul. 14, 2010

(30) Foreign Application Priority Data
Jan. 25, 2008 (DE) 10 2008 006 026.7

(51) Int. Cl. H01M 2/12

(52) U.S. Cl. 429/53

(57) ABSTRACT

The present invention relates to a device for the controlled transfer of electric mechanisms operating according to galvanic principles from a first operating state into at least a second operating state, in which the functionality and in particular the reaction potential of the electric mechanism operating according to galvanic principles is reduced or completely eliminated.

The present invention relates to a device for the controlled transfer of electric mechanisms operating according to galvanic principles from a first operating state into at least one second operating state in which the functionality and in particular the reaction potential of the electric mechanism operating according to galvanic principles is reduced or completely eliminated.

In the following, the invention is described with respect to a lithium ion secondary battery which is designated for the supply of the drive system of a motor vehicle. It is noted, however, that this is done in an exemplary way and the invention is not restricted to this application for lithium ion secondary batteries and not to the application in motor vehicles either. With a device according to the invention and the method for operating it, also other electric mechanisms operating according to galvanic principles can be transferred from a first operating state into at least one second operating state.

Electric mechanisms operating according to galvanic principles, for example lithium ion cells, which are worked into a secondary battery can be improved, as far as safety is concerned, in particular by ceramicly determined separators, like Separion. These separators containing ceramic material, like Separion, are in particular suited for lithium ion secondary batteries, as they distinguish themselves by a higher resistancy against thermal influences.

Basically, a lithium cell according to the prior art in a secondary battery becomes critical in the case of a misoperation state. A misoperation state is defined as a state which significantly affects or makes impossible a continued controlled or controllable and in particular safe operation of the secondary battery. Such misoperation states can be generated or triggered by a fault inside the secondary battery or by a fault in the environment of this secondary battery.

An misoperation state which has to be handled separately is the state of danger, which occurs due to an accident of the supplied motor vehicle or due to other, at least partially, destructive events. In a state of danger, a controllable and safe operation of the secondary battery is not possible anymore either. Moreover, a possible uncontrolled discharge of the stored energy leads to a particular hazard for the occupants of the motor vehicle or other persons in the neighborhood of the motor vehicle, for instance for rescue personnel. The controlled transfer into this second operating state is desirable also for their safety.

A hazard mainly occurs when the cell(s) overheat due to heavy heat development. Heavy heat development can be the consequence of internal and external shortcuts, reactions in connection with overcharging, overload, external heat sources, charging with high currents, charging with a high charging factor, start of charge at an already high temperature and bad cooling. Due to the increase of temperature, the electrolyte inside a cell heats up until it eventually evaporates. A conglomeration of electrolyte vapor resulting from this inside a cell sealed in a gas-proof way leads to an increasing interior pressure. When the interior pressure exceeds a limit value, the cell can explode, with the cell ingredients, which are harmful for humans, escaping or a fire being sparked.

There are safety mechanisms which counteract an excessive conglomeration of gas inside a cell and/or a cell stack sealed in a gas-proof way by giving the gases being generated the possibility to escape when the interior pressure of the cell exceeds a predetermined threshold value.

Safety mechanisms known from the prior art have valves which enable a pressure compensation. Such a suggestion can be found, for example, in the patent specification U.S. Pat. No. 5,523,178, which describes a valve for a cell. The realisation of such valves, however, leads to substantial difficulties in practice. Due to the high complexity of the valve design, the production effort and thus the cost of manufacturing a cell increases. Valves which are designed in a less complex way have the disadvantage that they only open at a high pressure or only in a narrow pressure range.

A further safety mechanism, which is known from the patent application US 2006/0019150 A1, suggests providing the housing of a cell or a cell stack with predetermined breaking points which slacken at a predetermined interior pressure and give vapor generated in a regular way a possibility to escape. Furthermore, such predetermined breaking points are designed in such a way that, when breaking, they disconnect the electrical conductivity between the equally polarized electrodes of a cell and the corresponding current conductor of the component assembly. It is a disadvantage of this embodiment that thereby, for example, a cell stack with just a single failed cell loses its whole functionality, that is the energy stored in the intact cells cannot be used anymore.

Both safety mechanisms which are known form the prior art have the disadvantage that they do not reduce or completely eliminate the danger potential, i.e. the reaction potential of a cell and/or a cell stack during a misoperation state and/or failure, but merely confine, at least partially, the resulting consequences. At the same time, the complexity of the cell and/or cell stack design is increased, which leads to an increased production effort and thus to a cost increase.

As a consequence of a failure and/or a misoperation state, in particular lithium ion secondary batteries can release more than seven times the amount of their theoretical energy by thermal decomposition reactions. At the end of the day, this cannot be avoided by choosing optimized components and design of the secondary batteries if the secondary battery is to be cost-effective.

As the safety requirements for lithium ion secondary batteries, in particular in the automotive industry, are very high and such a secondary battery is to be cost-effective at the same time, it would be desirable if the lithium secondary battery or at least a number of cells contained therein, in particular in a hybrid, electrical drive or in a stationary operation, would have lost the complete reaction potential, i.e. the electrical energy stored therein or the stored potential and thus its functionality, in a misoperation state and/or in the case of failure.

The safety mechanisms known in the prior art cannot fulfill these safety requirements while being cost-effective at the same time.

Therefore it is the objective of the present invention to provide a safety mechanism of the kind mentioned at the beginning which transfers electric mechanisms operating according to galvanic principles in a misoperation state of any kind and/or in the case of failure, in a controlled way into a non-dangerous operating state. Furthermore, a method shall be given which enables the determination of a misoperation state and which guarantees the controlled transition of the electric mechanism operating according to a galvanic principles.

This objective is reached according to the invention by the subject-matter of claim 1.

The method according to the invention for operating the device is the subject-matter of claim 10. Preferable extensions of the invention are the subject-matter of the sub-claims.

In the context of this invention, in particular cells and cell stacks for batteries or primary batteries as well as in particular rechargeable batteries or secondary batteries or accumulators are subsumed by the notion of an electric mechanism operating according to galvanic principles. These cells and/or cells stacks preferably have a cylindrical or a rectangular format. Such a cell or such a cell stack is usually accommodated in a gas-proof package, which preferably serves for preventing the permeation of humidity into the component assembly.

At least one shifting device is provided at the device according to the invention, which shifts an acting device from a first position to at least one second position.

In at least one (with the help of the shifting device) reachable position, the acting device manipulates the components of the electric mechanism operating according to galvanic principles in such a way that the galvanic functionality of the electric mechanism is reduced or completely eliminated. In particular, the separator of at least one cell is substantially irreversibly destroyed in the course of the manipulation, and/or the electrodes, i.e. the anode and the cathode of at least one cell are shortcut.

The shifting device is either stationarily integrated or accommodated in a, preferably portable, housing which is provided for this purpose. In both cases, the shifting device is positioned in such a way that the acting device is shiftable to a position which is advantageous for the aspired manipulation of the cell and/or of the cells.

Shifting energy which is transferable from the shifting device to the acting device is transformed into a drive-in force during the action of the acting device together with the electric mechanism operating according to galvanic principles. The shifting energy is preferably chosen in such a way that the drive-in force resulting from it is sufficiently large for penetrating at least one cell of the electric device operating according to galvanic principles.

Substantially, the amount of shifting energy to be transferred to the acting device is preferably chosen in such a way that the acting device selectively penetrates a pre-determined number of cells of the electric mechanism operating according to galvanic principles. This alignment offers the advantage that the electric potential of selected cells is substantially completely eliminated in a targeted way, whereas the galvanic functionality of the remaining cells of the component assembly is substantially preserved.

The shifting device has at least one internal and/or one external container, for example a magazine, for storing at least one acting device. In particular, however, several acting devices, preferably also of different lengths and/or preferably of different embodiments, are storable and can be taken out manually, or preferably automatically, on demand.

A releasing device, which triggers the functionality of the shifting device after appropriate signalling, in particular from a control device, is assigned to the shifting device.

The releasing device is preferably signal-connected to the control device.

There is at least one acting device provided at the device according to the invention which manipulates the electric mechanism operating according to galvanic principles or at least one cell arranged therein in such a way that the electric potential of the mechanism or of the cell, resp., and thus its galvanic functionality is reduced or completely eliminated.

The acting device substantially is a three-dimensional body which is, at least sectionwise, electrically conductive substantially in at least two dimensions. Depending on the embodiment, single volume elements of the acting device can therefore be formed of non-conductive materials, for example ceramics.

In a preferred embodiment, the form of the acting device is rotationally and/or axially symmetrical. In particular, the form of the acting device is designed in an ellipsoidal, conical, cylindrical, pyramidal or cuboid way or in a combination of these forms.

In an alternative embodiment, the form of the acting device is such that it extends, starting at a two-dimensional end face, into the third dimension, thus having at least one lateral surface, and is closed by a second end face. This first end face is delimited by a polygon or another closed curve. Preferably, these end faces are congruent, not rotated against each other, and arranged in a parallel way. Preferably, the acting device extends orthogonally from this first end face.

In an alternative embodiment, the form of the acting device is not rotationally and/or axially symmetrical, but has a form which is different from this, for instance wave-shaped side faces and/or covering surfaces and/or lateral surfaces.

The acting device can either be filled inside or can have at least one cavity. A hollow acting device in particular offers the advantage that in this way smoke which is regularly generated during the controlled transition of the electric mechanism operating to galvanic principles into a non-dangerous operating state can escape.

In particular, the acting device is thermally sufficiently stable to withhold shortcut currents flowing through it which are substantially in the range of one to several hundred Ampere.

The mechanical stability of the acting device is designed in such a way that an energy can be transferred from the shifting device to the acting device which is sufficient for at least one component and/or cell of the electric mechanism operating according to galvanic principles to be penetrated. Moreover, the acting device is mechanically resilient in such a way that at least one component and/or one cell as well as the shell of an electric mechanism operating according to galvanic principles can be penetrated by it.

The acting device is deposited in a dedicated container, for example a magazine. Here, the container is mounted inside and/or outside the shifting device in such a way that the acting device can be taken out manually or preferably automatically on demand.

Alternatively, the acting device can also be designed as a component of the shifting device.

The device according to the invention has at least one control device, preferably a program-controlled microprocessor, which processes the incoming sensor signals and/or signals of the safety electronics and controls the transmission of control signals to the releasing and/or the shifting device.

The control device is preferably signal-connected to the sensor devices and/or electronics for determining a misoperation state and/or failure. In particular, this design of the control device offers the advantage that it is not sensitive to interfering signals, as it would be the case, for instance, for a wireless signal transmission.

In an alternative embodiment, the control device communicates wirelessly with the releasing and/or the shifting device and/or the sensor devices and/or the safety electronics. The control device is equipped with a corresponding transmitting device and/or a receiving device then. The transmitting device has a control device of its own, preferably a program-controlled microprocessor, which controls the transmission of the control signals. Furthermore, the transmitting device has a signalling device generating an identification signal which is characteristic of the respective transmitting device. This signal is transmitted at least once before or after the transmission of the control signal.

A memory is assigned to the receiving device in which an identification compare signal is stored which is assigned to the identification signal of an individual transmitting device of the sensor devices and/or of the safety electronics. The identification signal either exactly corresponds to the identification compare signal, or it is assigned to the identification compare signal via a, preferably mathematical, relation. A comparing device is provided in the receiving device which causes a sensor device signal and/or a safety electronics signal to be further processed only if the identification signal transmitted by the individual transmitting device of a sensor device and/or of a safety electronics and received by the receiving device, is identical to, or is assigned to, resp., the identification compare signal stored in the receiving device.

This design leads to an extraordinarily high reliability of the control device and a strong protection against disturbances of the data transmission between the transmitting device and the receiving device.

The above and further features and advantages of the invention become more comprehensible from the subsequent descriptions of preferable, non-limiting embodiments, where reference is made to the attached drawings, which show:

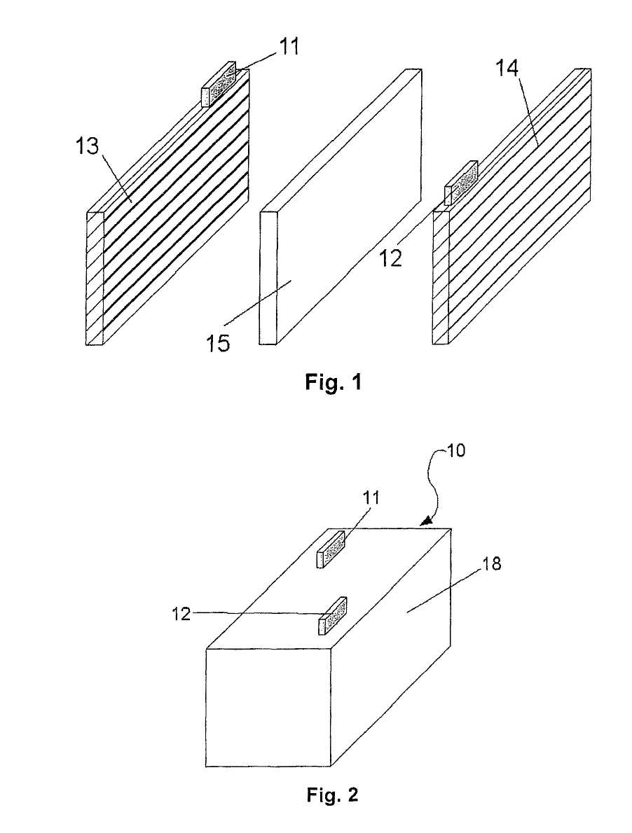

FIG. 1 the components of a basic cell of electric mechanisms operating according to galvanic principles;

FIG. 2 a heavily diagrammed perspective view of a basic cell of electric mechanisms operating according to galvanic principles;

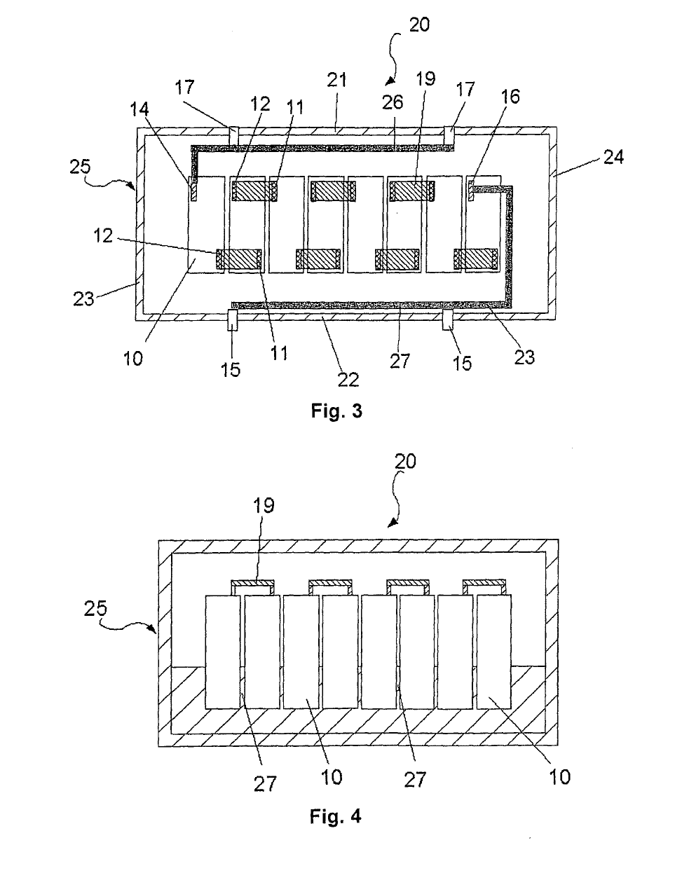

FIG. 3 a heavily diagrammed top view of an electric mechanism operating according to galvanic principles;

FIG. 4 a heavily diagrammed side view of an electric mechanism operating according to galvanic principles;

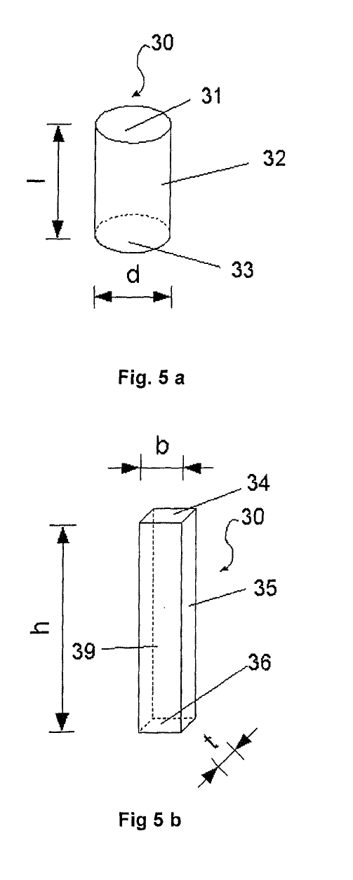

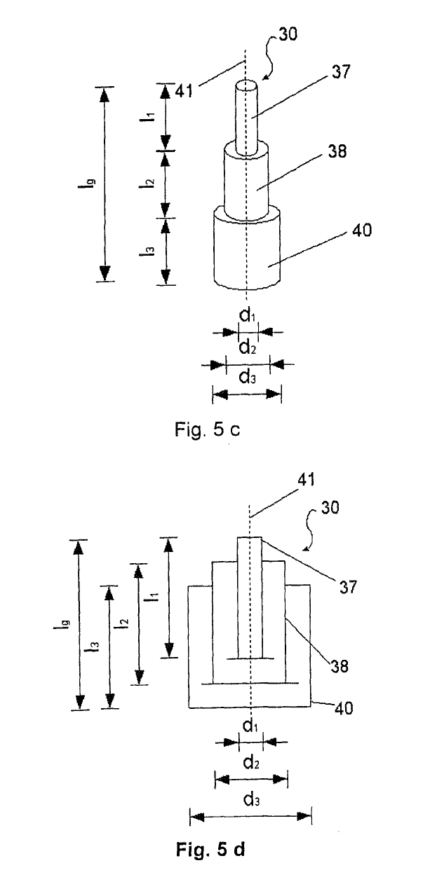

FIG. 5 a a heavily diagrammed perspective view of a cylindrical acting device;

FIG. 5 b a heavily diagrammed perspective view of a cuboid acting device;

FIG. 5 c a heavily diagrammed perspective view of a cylindrical telescope acting device;

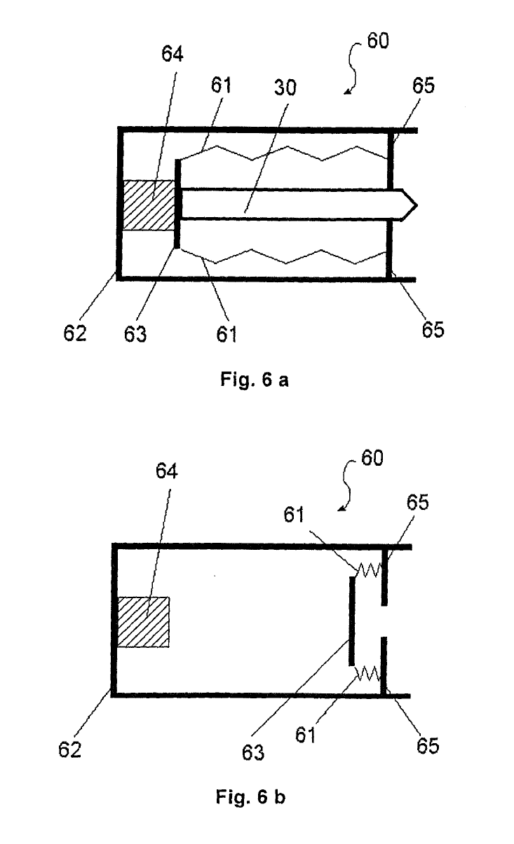

FIG. 6 a-b a heavily diagrammed, substantially mechanically based shifting device;

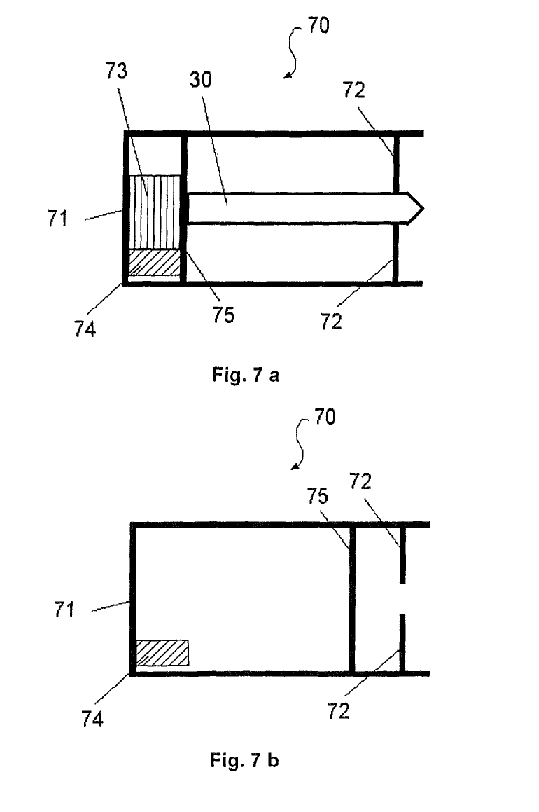

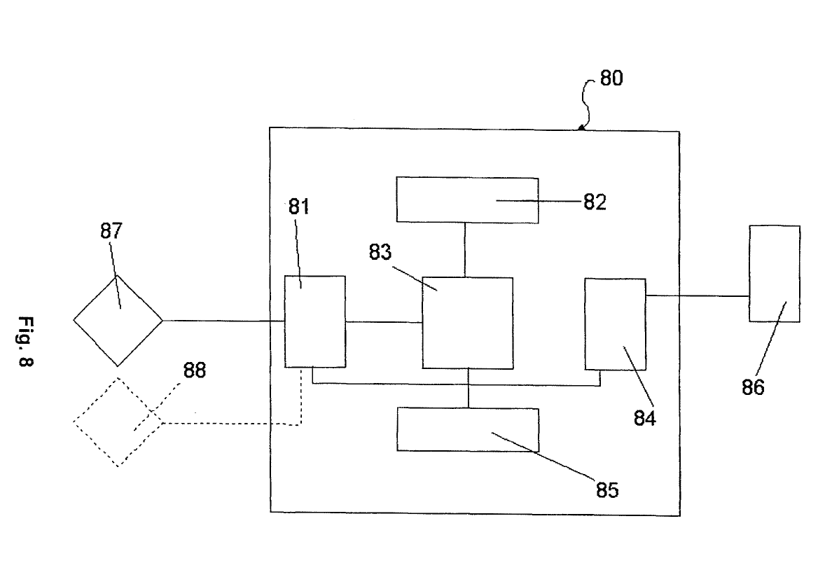

FIG. 7 a-b a heavily diagrammed, substantially chemically based shifting device;

FIG. 8 a diagrammed block diagram of the control device.

At first, the basic structure of an electric mechanism operating according to galvanic principles is described using FIGS. 1 to 4.

FIG. 1 shows the essential components of a basic cell 10 of an electric mechanism operating according to galvanic principles, as, for example, a lithium ion battery. Between the positively charged electrode (anode) 13 and the negatively charged electrode (cathode) 14, a separator 15 is applied. The anode 13 is equipped with a current deflector 11, and the cathode 14 is equipped with a current deflector 12.

FIG. 2 shows a heavily diagrammed perspective view of a basic cell 10 of electric mechanisms operating according to galvanic principles. The basic cell 10 is substantially constructed from an anode 13, a cathode 14 and a separator 15. These components are accommodated in a substantially gas-proof packaging 18. The current deflector 11 of the anode 13 and the current deflector 12 of the cathode 14 extend from the packaging.

FIG. 3 shows an embodiment in which, according to a predetermined wiring, eight lithium secondary basic cells 10 are integrated as a stack cell 20. This cell has negative and positive output terminals 15, 17. In this stack cell 20, the positive output terminals 17 and the negative output terminals 15 are designed as distinguishable plug connections fitting into each other. The positive output terminals 17 and the negative output terminals 15 are applied, separately from each other, at predetermined positions, a front surface 21 and a rear surface 22 opposite to this front surface, of the cell stack. The positions of the output terminals 15, 17 are chosen such that several stack cells 20 can be plugged together to a larger module.

The embodiment shown in FIG. 3 and FIG. 4 of the electric mechanism 20 operating according to galvanic principles provides an output voltage of 24 Volt by connecting eight basic cells 10 with an output voltage of 3 Volt each in series.

As it is apparent from FIG. 3 and FIG. 4, the basic cells 10 are accommodated in a housing 25 and are separated from each other by separating elements 27. The basic cells 10 are alternately arranged in such a way that in each case the current deflector 11 of the anode 13 and the current deflector 12 of the cathode 14 of neighbouring basic cells 10 are arranged close together. The current deflector 11 of the anode 13 is connected in series with the current deflector 12 of the cathode 14 of the directly neighbouring basic cell 10 in an electrically conductive way by shortcut elements 19, resulting in a serial connection of the basic cells 10. The two end poles 14, 16 are connected by conductive path 26, 27 either to the positive output terminals 17 or to the negative output terminals 15 corresponding to their polarity.

FIG. 5 a-FIG. 5 d show preferred embodiments of the acting device 30.

FIG. 5 a shows a heavily diagrammed perspective view of a cylindrical acting device 30 with a circular covering surface 31 and a circular base surface 33, which are connected by a lateral surface 32. The thickness d and the length l of the acting device 30 are chosen in an application-specific way. In particular, the thickness d is not constant across the total length l, but can be varied. In particular, the design of the covering surface 31 and the base surface 33 is variable. For instance, they can be designed as ellipses.

FIG. 5 b shows a heavily diagrammed perspective view of a cuboid acting device 30 with a rectangular covering surface 34 and a rectangular base surface 36, which are connected by rectangular side surfaces 35, 39. They height h, the breadth b, as well as the depth t of the acting device 30 are chosen in an application-specific way. In particular, the breadth b and/or the depth t are not constant across the complete height, but can be varied.

FIG. 5 c shows a heavily diagrammed perspective view of a cylindrical telescope acting device 30 which is composed from three cylindrical components 37, 38 and 40. The components are shiftable against each other along a longitudinal axis 41. The maximum total length l_{g} of the acting device 30 results from the addition of the component length l₁ of component 37, the component length l₂ of component 38 and the component length l₃ of component 40. The thicknesses d₁, d₂ and d₃ of components 37, 38 and 40 must substantially fulfill the mathematical condition d₁<d₂<d₃. The component lengths l₁, l₂ and l₃ as well as the component thicknesses d₁, d₂ and d₃ of components 37, 38 and 40 are chosen in an application-specific way.

FIG. 5 d shows a heavily diagrammed side view of a cross-section along the longitudinal axis 41 of the cylindrical telescope acting device 30 from FIG. 5 c. The total length l_{g} is not maximal here, because the components 37, 38 and 40 are not completely pulled out.

FIG. 6 a shows a first, heavily diagrammed embodiment of a shifting device 60, which is equipped with an acting unit 30 and is in a first, ready-to-operate state. The shifting device 60 consists of a housing having a clearly confined opening on one side 65. The opening is designed in such a way that the acting unit 30 can be passed through it. The necessary shifting energy is stored in a mechanical way, for example by stressed spring elements 61, one end of each spring element 61 being fixed to the housing and the respective other end of the spring element 61 being fixed to the movable object carrier 63. The movable object carrier 63 is kept in a first position by a releasing device 64, as, for example, an electromagnet, for preserving the energy stored in the spring elements 61. After receiving a corresponding release signal, the releasing device 64 releases the object carrier, by means of which the energy stored in the spring elements 61 is transferred to the acting unit 30 in the form of a shifting energy. After release, the shifting device 60 is in a second operating state, which is represented in FIG. 6 b in a heavily diagrammed way. The object carrier 63 is not kept by the releasing device 64 therein anymore, and the spring elements 61 are substantially not stressed anymore.

FIG. 7 a shows a second, heavily diagrammed embodiment of a shifting device 70 which is equipped with an acting unit 30 and is in a first, ready-to-operate state. The shifting device 70 consists of a housing 71, which has a clearly confined opening on one side 72. The opening is designed in such a way that the acting unit 30 can be passed through it. The necessary shifting energy is stored in a chemical way, for example by a propellant 73. This propellant 73 is arranged inside a first partial volume of the shifting device 70, which is substantially tightly sealed by the movable object carrier 75 and the housing 71. Here, the object carrier 75 is in a first position. After receiving a corresponding release signal, the releasing device 74, for example an electronic igniter, triggers the function of the shifting device 70. By the energy which is released by the exothermal reaction of the ignited propellant 73, in connection with a corresponding volume change, the object carrier 75 is moved in the shifting direction, which transfers the chemically stored energy substantially as shifting energy preferably to the acting unit 30. After release, the shifting device 70 preferably is in a second operating state, which is represented in FIG. 7 b in a heavily diagrammed way. The object carrier 75 is in a second position therein, and the propellant 75 is substantially consumed.

The control device 80 of the device according to the invention is, as it is apparent from the following description with respect to FIG. 8, connected to at least one sensor device 87 and/or at least one safety electronics 88 and the releasing device 86 of the shifting device via electrical conductors, which are always represented merely in a diagrammed way here and in the following.

Preferably, a piezoelectric sensor is used as a sensor device. In such a sensor, a small piezoceramic sensor plate transforms dynamic pressure fluctuations into electrical signals, which can be further processed accordingly.

The signal of the sensor device, which is analog in the embodiment, is transformed into a digital signal in a signal processing circuit 81 by means of an A/D converter. The digitally processed signal is fed into a microprocessor calculating unit 83 which is connected to a memory 82. In the memory 82, which can be arbitrarily subdivided into single, even different, storage areas, a program controlling the microprocessor is stored either in a read-only memory or in a memory whose contents are stored in the long term by means of the battery voltage. The input signals of at least one sensor device and/or of the safety electronics are analyzed by the microprocessor. If a misoperation state and/or a failure is determined, the microprocessor 83 generates a corresponding transmission signal for the releasing device, which is fed to a transmitter output stage 84. The signal is transmitted from the transmitter output stage to the releasing device 86 of the shifting device. A battery, preferably a lithium ion battery, is provided for the power supply of the control device.

1. Device for the controlled transfer of electric mechanisms operating according to galvanic principles, as in particular batteries, accumulators or fuel cell stacks, from a first operating state into at least one second operating state in which the functionality of the electric mechanism is reduced, comprising
at least one acting device being provided which is kept in at least one first position in the first operating state of the electric mechanism; and
at least one shifting device by which the acting device is shiftable from the first position to at least one second position such that the acting device acts together with components of the electric mechanism in such a way that the galvanic functionality of the electric mechanism is reduced or completely eliminated, characterized in that at least one releasing device is provided which substantially triggers the functionality of the shifting device, and that at least one control device is provided which is signal-connected to at least one releasing device and/or one shifting device.

2. Device according to claim 1, characterized in that the shifting device can transfer a shifting energy to the acting device in such a way that the acting device penetrates at least one cell of the electric mechanism operating according to galvanic principles.

3. Device according to claim 1, characterized in that the acting device can store a sufficient shifting energy and can transform this shifting energy into a drive-in force in such a way that at least one cell of the electric mechanism operating according to galvanic principles is penetrated by the acting device.

4. Device according to claim 1, characterized in that the acting device is, at least sectionwise, electrically conductive in its horizontal and/or vertical spatial dimension.

5. Device according to claim 1, characterized in that at least one control device is signal-connected to at least one sensor device and/or at least one electronic device.

6. Device according to claim 1, characterized in that the electric mechanism operating according to galvanic principles has at least one cell in which at least two separate areas with manipulable electric potentials are provided.

7. Device according to claim 1, characterized in that the electric mechanism operating according to galvanic principles is in particular a rechargeable device for electrochemically storing electric energy.

8. Method for the controlled transfer of electric mechanisms operating according to galvanic principles, as in particular batteries, accumulators or fuel cell stacks, from a first operating state into at least one second operating state in which the functionality of the electric mechanism is reduced, the method comprising at least one acting device being kept in at least a first position in the first operating state of the electric mechanism and being shifted by at least one shifting device from the first position into at least one second position, the acting device thus acting together with components of the electric mechanism in such a way that the galvanic functionality of the electric mechanism is reduced or completely eliminated, characterized in that substantially at least one releasing device triggers the shifting device.

9. Method according to claim 8, characterized in that the acting device stores a sufficient shifting energy and transforms the shifting energy into a drive-in force in such a way that at least one cell of the electric mechanism operating according to galvanic principles is penetrated by the acting device.

10. Method according to claim 8, characterized in that the shifting device transfers a shifting energy to the acting device in such a way that the acting device penetrates at least one cell of the electric mechanism operating according to galvanic principles.

11. Method according to claim 8, characterized in that sensor devices and/or electric devices determine a misoperation state or a case of mishandling.

12. Method according to claim 8, characterized in that sensor devices and/or electric devices can control at least one releasing and/or one shifting device after determining a misoperation state and/or a case of mishandling.

13. Method according to claim 8, characterized in that the acting device acts together with the electric mechanism operating according to galvanic principles in such a way that the galvanic functionality of at least one cell contained therein is reduced or completely eliminated.

14. Method according to claim 9, characterized in that:
the acting device stores a sufficient shifting energy and transforms the shifting energy into a drive-in force in such a way that at least one cell of the electric mechanism operating according to galvanic principles is penetrated by the acting device;
the shifting device transfers a shifting energy to the acting device in such a way that the acting device penetrates at least one cell of the electric mechanism operating according to galvanic principles;
sensor devices and/or electric devices determine a misoperation state or a case of mishandling;
sensor devices and/or electric devices can control at least one releasing and/or one shifting device after determining a misoperation state and/or a case of mishandling and
the acting device acts together with the electric mechanism operating according to galvanic principles in such a way that the galvanic functionality of at least one cell contained therein is reduced or completely eliminated.

15. Device according to claim 2, characterized in that:
the shifting device can transfer a shifting energy to the acting device in such a way that the acting device penetrates at least one cell of the electric mechanism operating according to galvanic principles;
the acting device can store a sufficient shifting energy and can transform this shifting energy into a drive-in force in such a way that at least one cell of the electric mechanism operating according to galvanic principles is penetrated by the acting device;
the acting device is, at least sectionwise, electrically conductive in its horizontal and/or vertical spatial dimension;
at least one control device is signal-connected to at least one sensor device and/or at least one electronic device;
the electric mechanism operating according to galvanic principles has at least one cell in which at least two separate areas with manipulable electric potentials are provided; and
the electric mechanism operating according to galvanic principles is in particular a rechargeable device for electrochemically storing electric energy.
